(19) United States
(12) Patent Application Publication
(10) Pub. No.: US 2005/0155250 A1
(43) Pub. Date: Jul. 21, 2005

(54) Clothes drying apparatus

(75) Inventors: Young Suk Chung, Suwon-si (KR); Jin Sung Lee, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., LTD., Suwon-si (KR)

(21) Appl. No.: 10/926,949

(22) Filed: Aug. 27, 2004

(30) Foreign Application Priority Data
Jan. 19, 2004 (KR) 2004-3884

(51) Int. Cl. F26B 21/06; F26B 11/02

(52) U.S. Cl. 34/602; 34/604

(57) ABSTRACT

A clothes drying apparatus including: a rotating drum; an intake duct which delivers hot air to the rotating drum; and an air inlet section at the rotating drum and in communication with the intake duct. The air inlet section is configured to radially supply the hot air from the intake duct into the rotating drum.

### CROSS-REFERENCE TO RELATED APPLICATION

This application claims the benefit of Korean Patent Application No. 2004-3884, filed on Jan. 19, 2004 in the Korean Intellectual Property Office, the disclosure of which is incorporated herein by reference.

### BACKGROUND OF THE INVENTION

1. Field of the Invention

The present invention relates to a clothes drying apparatus, and more particularly, to a clothes drying apparatus having a structured air inlet section provided at a rear end of a rotating drum which radially delivers air into the rotating drum, and improves drying performance.

2. Description of Related Art

Generally, clothes drying machines are adapted to dry clothes contained in a rotating drum horizontally arranged in a housing by a flow of hot air passing through the rotating drum during rotation of the rotating drum at low speed in one direction.

Such a clothes drying machine includes a rotating drum for receiving clothes to be dried, an intake duct for supplying hot air into the rotating drum, an exhaust duct for exhausting the hot air after the air is circulated in the rotating drum, and a driving unit for rotating the rotating drum in order to rapidly dry the clothes.

A heater is installed in the intake duct in order to heat air introduced into the intake duct. An exhaust fan is installed in the exhaust duct in order to forcibly externally vent hot air introduced into the rotating drum through the intake duct. An air inlet section is provided at a rear panel mounted to a rear end of the rotating drum and in communication with the intake duct, so as to guide the introduction of hot air into the rotating drum.

In a general clothes drying apparatus, such an air inlet section has a flat plate structure provided with a plurality of holes, and is arranged at a central portion of a rear panel mounted to a rear end of a rotating drum, as shown in FIG. 5 of Korean Patent Laid-open Publication No. 2001-73539.

Due to such a structure of the air inlet section, hot air is introduced into the rotating drum in a straight direction at a high flow velocity, so that it is locally supplied to a portion of the interior of the rotating drum. Accordingly, in the interior of the rotating drum, there is a dead region where hot air cannot reach, thereby reducing the contact area of hot air with the clothes. As a result, the drying efficiency of the clothes drying apparatus is degraded.

### BRIEF SUMMARY

Therefore, an aspect of the invention is to provide a clothes drying apparatus having an improved structure of an air inlet section provided at a rear panel mounted to a rear end of a rotating drum, thereby being capable of increasing the flow rate and flow velocity of hot air introduced into the rotating drum while using a small fan size, and thus, allowing the hot air to be uniformly supplied into the entire portion of the interior of the rotating drum without forming a dead region where hot air cannot reach, and increasing the contact area of the hot air with clothes to achieve an enhancement in drying efficiency.

According to an aspect of the present invention, there is provided a clothes drying apparatus including: a rotating drum; an intake duct which delivers hot air to the rotating drum; and an air inlet section at the rotating drum and in communication with the intake duct. The air inlet section is configured to radially supply the hot air from the intake duct into the rotating drum.

The air inlet section may have a plurality of through holes extending radially through the convex structure.

The air inlet section may have a diameter about equal to a diameter of the intake duct.

The intake duct may have an inlet portion and the apparatus may include a heater installed in the inlet portion to heat air drawn into the intake duct.

According to another aspect of the present invention, there is provided a clothes drying apparatus including: a rotating drum having a front end and a rear end; an intake duct which delivers hot air to the rotating drum; an exhaust duct which exhausts heat exchanged air heated by heat exchange in the rotating drum; and an air inlet section at the rotating drum and in communication with the intake duct. The air inlet section is at a rear panel mounted to the rear end and has a convex structure which protrudes into the rotating drum. The exhaust duct is connected, at an inlet portion thereof, to a front panel mounted to the front end.

According to still another aspect of the present invention, there is provided an air inlet of a clothes drying apparatus which uses a rotating drum, including: an air receiving portion in communication with an ambient and which receives air to be delivered into the rotating drum; and an air delivering portion having a convex wall extending into the rotating drum and having a plurality of through holes extending through the convex wall. The air received by the receiving portion is radially delivered to the drum through the plurality of through holes.

According to another aspect of the present invention, there is provided a method of drying clothes in a clothes drying apparatus using a drum, including: rotating the drum; heating air; delivering the heated air to the drum; and radially supplying the heated air into the drum via an air inlet having a convex wall extending into the rotating drum and having a plurality of through holes extending radially through the convex wall and through which the hot air enters the drum.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 is a sectional view schematically illustrating a clothes drying apparatus according to an embodiment of the present invention;

FIG. 2 is an enlarged sectional view of portion A of FIG. 1, illustrating an air inlet section according to the embodiment shown in FIG. 1; and

FIG. 3 is a front view of the clothes drying apparatus of FIG. 1.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

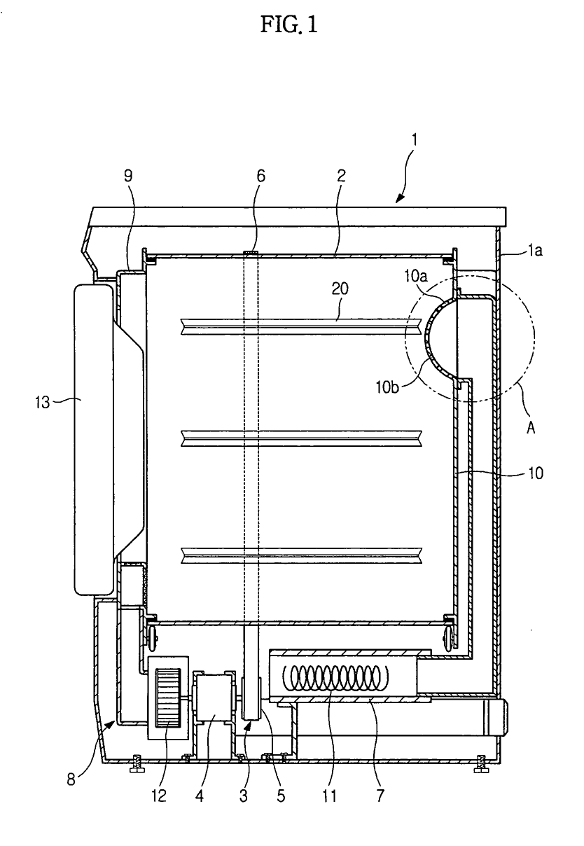

FIG. 1 is a sectional view schematically illustrating a clothes drying apparatus according to an embodiment of the present invention.

As shown in FIG. 1, the clothes drying apparatus according to the illustrated embodiment of the present invention includes a housing 1, a rotating drum 2 installed in the housing 1, and adapted to receive clothes to be dried, and a door 13 for opening and closing an opening formed at a front panel 9 mounted to a front end of the rotating drum 2.

The housing 1 has an approximately box shape. The door 13 is pivotably mounted to a front wall of the housing 1 to allow the user to put clothes, to be dried, into the rotating drum 2 through the opening formed at the front panel 9, or to take dried clothes out of the rotating drum 2 through the opening. The housing 1 is provided, at a rear wall 1 a thereof, with intake holes (not shown) for introducing ambient air into an intake duct 7.

The rotating drum 2 has a cylindrical structure with openings at front and rear ends thereof. Front and rear panels 9 and 10, respectively, are mounted to the front and rear ends of the rotating drum 2, respectively, to close the rotating drum 2 while allowing the rotating drum 2 to be rotatable with respect therewith. The rotating drum 2 is made of a stainless steel, e.g., because it dries clothes by use of hot air.

The rotating drum 2 is configured to dry clothes while rotating at low speed. To this end, the clothes drying apparatus also includes a driving unit 3, and a drive motor 4. The driving unit 3 is coupled to a shaft (not shown) of the drive motor 4. The driving unit 3 includes a pulley 5 coupled to the shaft of the drive motor 4, and a belt 6 connected between the pulley 5 and the rotating drum 2. With this configuration, the driving unit 3 transmits a drive force from the drive motor 4 to the rotating drum 2. Although a specific belt drive arrangement has been described, it is to be understood that other drive arrangements are possible.

The front and rear panels 9 and 10 are fixedly mounted to the housing 1 such that they rotatably support the rotating drum 2. In order to reduce friction generated between each of the front and rear panels 9 and 10 and an associated peripheral end of the rotating drum 2, a friction reducing member 30 is interposed between each of the front and rear panels 9 and 10 and the associated peripheral end of the rotating drum 2.

A plurality of lifters 20 are arranged on an inner peripheral surface of the rotating drum 2 while being uniformly circumferentially spaced apart from one another. The lifters 20 serve to raise the cloths to the top of the rotating drum 2, and then release the clothes at a desired level to cause the clothes to be dropped to the bottom of the rotating drum 2, in accordance with rotation of the rotating drum 2, in order to cause the clothes to be uniformly dried.

The clothes drying apparatus is configured to dry clothes in accordance with a hot air circulation process for sucking air, heating the sucked air to generate hot air, and venting exhausted hot air. To this end, the clothes drying apparatus also includes the intake duct 7, a heater 11, and an exhaust duct 8.

The intake duct 7 is opened at its inlet portion while being connected at its outlet portion to the rear panel 10. The intake duct 7 extends vertically to have the inlet portion at a lower end thereof while having the outlet portion at an upper end thereof. The heater 11 is arranged in the intake duct 7 to heat air introduced into the intake duct 7. The heater 11 may be an electric heating wire or an electric heating wire sheathed with ceramic. In this embodiment of the present invention, the heater 11 is arranged at an inlet portion of the intake duct 7.

The exhaust duct 8 is connected, at an inlet portion thereof, to the front panel 9 while being opened at an outlet portion thereof. The outlet portion of the exhaust duct 8 extends externally beyond the housing 1. An exhaust fan 12 is arranged in the exhaust duct 8. With this configuration, ambient air around the housing 1 can be introduced into the rotating drum 2 via the intake duct 7, and then forcibly vented out of the housing 1 via the exhaust duct 8. The exhaust fan 12 is rotated by the drive motor 4, along with the rotating drum 2.

The rear panel 10 is provided with an air inlet section 10a communicating with the intake duct 7. The air inlet section 10a has a dome structure protruded into the interior of the rotating drum 2. The air inlet section 10a is provided with a plurality of through holes 10 extending radially through the air inlet section 10a. The air inlet section 10a has a diameter approximately equal to the diameter of the outlet portion of the intake duct 7.

In this embodiment of the present invention, the air inlet section 10a is integral with the rear panel 10. However, the air inlet section 10a may be formed as a separate member. In this case, the air inlet section 10a may be attached to the rear panel 10. However, where the air inlet section 10a is integral with the rear panel 10, there are advantages in terms of reduction in air resistance, and reduction in machining costs and material costs.

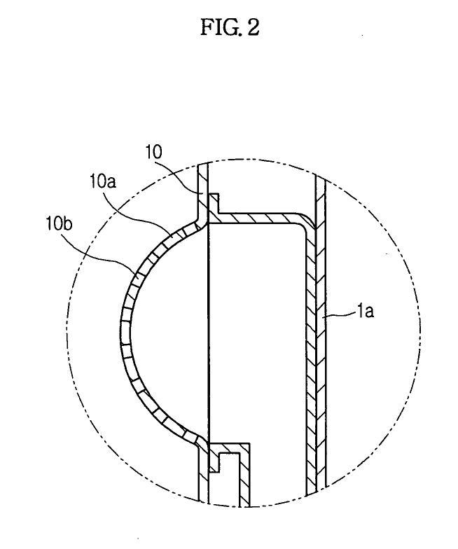

FIG. 2 is an enlarged sectional of portion A of FIG. 1. FIG. 2 illustrates an air inlet section according to this embodiment of the present invention.

As described above, the air inlet section 10a has a convex structure, that is, a dome structure, protruded into the interior of the rotating drum 2. The diameter of the air inlet section 10a may be vary depending on myriad factors including, for example, the heater performance and drying efficiency of the clothes drying apparatus, and respective sizes of the intake and exhaust ducts.

The through holes 10b provided at the air inlet section 10a extend radially through the air inlet section 10a, as described above. By virtue of such a structure of the through holes 10b, hot air is introduced into the interior of the rotating drum 2 in radial directions, so that it can be supplied into the rotating drum 2 in an enlarged region. For the same purpose, the through holes 10b may have different sizes or a non-uniform arrangement. It will be appreciated by those skilled in the art that various designs of the through holes 10b may be implemented within the scope of the present invention.

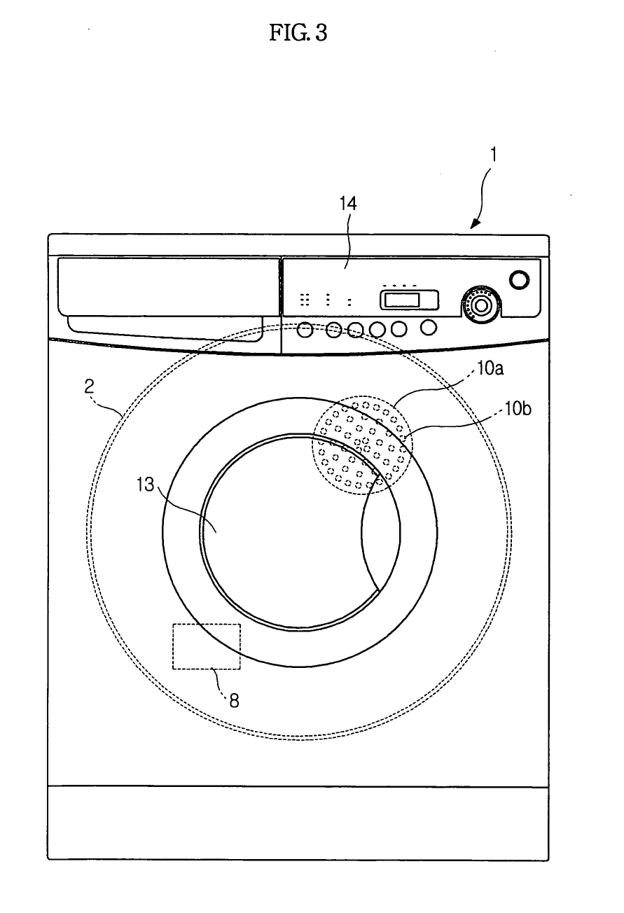

FIG. 3 is a front view of a clothes drying apparatus according to this embodiment of the present invention.

A controller 14 adapted to control a drying cycle of the clothes drying apparatus is provided at an upper portion of the front wall of the housing 1. The controller 14 includes a plurality of buttons for allowing the user to set a desired drying mode, and a display panel for displaying an operating state of the clothes drying apparatus. The door 13 is arranged beneath the control unit 14. Referring to FIG. 3, the door 13, the rotating drum 2 installed in the housing 1, the air inlet section 10a communicating with the rotating drum 2 to introduce air into the rotating drum 2, and the inlet portion of the exhaust duct 8 adapted to vent hot air from the rotating drum 2 are shown.

As shown in FIG. 3, the air inlet section 10a is arranged at a right upper portion of the rear panel 10 mounted to the rear end of the rotating drum 2. Of course, the air inlet section 10a may be arranged at any position of the real panel 10. However, since the exhaust duct 8 is arranged at a left lower portion of the front panel 9 mounted to the front end of the rotating drum 2, the air inlet section 10a is arranged at a position diagonal to the position of the exhaust duct 8 in the illustrated embodiment of the present invention, in order to allow hot air radially injected into the rotating drum 2 through the air inlet section 10a to perform heat exchange with clothes, contained in the rotating drum 2, in an enlarged region.

The air inlet section 10a may also be arranged at a left upper portion of the rear panel 10 mounted to the rear end of the rotating drum 2. In this case, the exhaust duct 8 may be arranged at a right lower portion of the front panel 9 mounted to the front end of the rotating drum 2. Since the rotating drum 2 rotates, there is little difference between the case in which the air inlet section 10a is arranged at the left upper portion of the rear panel 10 and the case in which the air inlet section 10a is arranged at the right upper portion of the rear panel 10.

Now, the operation and effect of the clothes drying apparatus provided with the air inlet section 10a in accordance with this embodiment of the present invention will be described in detail.

First, the user puts clothes to be dried into the rotating drum 2, and then closes the door 13. When the user subsequently operates the clothes drying apparatus, the drive motor 4, exhaust fan 12, and heater 11 are energized and the rotating drum 2 is rotated at low speed. Simultaneously, ambient air around the housing 1 is introduced into the intake duct 7.

With the rotation of the rotating drum 2, the clothes are sequentially upwardly raised from the bottom of the rotating drum 2 by the lifters 20, and then dropped from the top of the rotating drum 2 onto the bottom thereof. The air introduced into the intake duct 7 is heated by the heater 11, and then fed to the rotating drum 2 through the through holes 10b of the air inlet section 10a of the rear panel 10.

That is, ambient air is heated by the heater 11 while passing through the intake duct 8, and is then fed toward the upper end of the intake duct 8 in accordance with a rising effect thereof and a blowing force of the exhaust fan 12. The hot air is then introduced into the rotating drum 2 while passing through the through holes 10b of the air inlet section 10b.

The hot air is uniformly radially spread in the rotating drum 2 as it is radially introduced into the rotating drum 2 through the through holes 10b. Since the rotating drum 2 rotates, the hot air supplied in the rotating drum 2 can reach not only clothes raised by the lifters 20, and then dropped, but also clothes placed on the bottom of the rotating drum 2.

Meanwhile, the hot air has increased humidity due to its absorption of humidity from the clothes coming into contact therewith, so that it tends to be mainly distributed in a lower portion of the rotating drum 2. This hot air is outwardly vented through the exhaust duct 8 in accordance with the blowing force of the exhaust fan 12, so that it is exhausted to the exterior of the clothes drying apparatus. As described above, the hot air is introduced into the rotating drum 2 not only in parallel directions, but also in radial directions, so that it is uniformly spread in the interior of the rotating drum 2 without being locally concentrated at a portion of the interior of the rotating drum 2.

As is apparent from the above description, in accordance with the present invention, the air inlet section provided at the rear panel mounted to the rear end of the rotating drum has an improved structure. Accordingly, it is possible to increase the flow rate and flow velocity of hot air introduced into the rotating drum while using a small fan size. The hot air can also be uniformly supplied into the entire portion of the interior of the rotating drum, so that there is no dead region where hot air cannot reach. Accordingly, the contact area of hot air with clothes increases, thereby enhancing the drying efficiency of the clothes drying apparatus.

Although a few embodiments of the present invention have been shown and described, the present invention is not limited to the described embodiments. Instead, it would be appreciated by those skilled in the art that changes may be made in these embodiments without departing from the principles and spirit of the invention, the scope of which is defined by the claims and their equivalents.

1. A clothes drying apparatus comprising:
a rotating drum;
an intake duct which delivers hot air to the rotating drum; and
an air inlet section at the rotating drum and in communication with the intake duct,
wherein the air inlet section is configured to radially supply the hot air from the intake duct into the rotating drum.

2. The apparatus of claim 1, wherein the air inlet section has a convex structure which protrudes into the rotating drum.

3. The clothes drying apparatus according to claim 1, wherein the air inlet section has a plurality of through holes extending radially through the convex structure.

4. The clothes drying apparatus according to claim 1, wherein the air inlet section has a diameter about equal to a diameter of the intake duct.

5. The clothes drying apparatus according to claim 1, wherein the intake duct has an inlet portion and the apparatus further comprises a heater installed in the inlet portion to heat air drawn into the intake duct.

6. The apparatus of claim 1, further comprising an air heater disposed in the intake duct.

7. The apparatus of claim 6, wherein the air heater includes one of an electrically heated wire and a ceramic coated electrically heated wire.

8. A clothes drying apparatus comprising:
a rotating drum having a front end and a rear end;
an intake duct which delivers hot air to the rotating drum;
an exhaust duct which exhausts heat exchanged air heated by heat exchange in the rotating drum; and
an air inlet section at the rotating drum and in communication with the intake duct,
wherein the air inlet section is at a rear panel mounted to the rear end and has a convex structure which protrudes into the rotating drum, and
wherein the exhaust duct is connected, at an inlet portion thereof, to a front panel mounted to the front end.

9. The clothes drying apparatus according to claim 8, wherein the air inlet section has a plurality of through holes extending radially through the convex structure.

10. The clothes drying apparatus according to claim 8, wherein the air inlet section has a diameter about equal to a diameter of the intake duct.

11. The clothes drying apparatus according to claim 8, wherein the intake duct has an inlet portion and the apparatus further comprises a heater installed in the inlet portion to heat air drawn into the intake duct.

12. The clothes drying apparatus according to claim 5, further comprising an exhaust fan installed at a bottom portion of the housing, and in communication with the exhaust duct.

13. The apparatus of claim 8, wherein the air inlet section is integral with the rear panel.

14. The apparatus of claim 8, wherein the air inlet section is disposed at an upper portion of the rear panel.

15. The apparatus of claim 8, wherein the exhaust duct is located at a lower portion of the rear panel.

16. The apparatus of claim 8, wherein the air inlet section and the exhaust duct are located at opposing corners of the rear panel and the front panel.

17. The apparatus of claim 8, further comprising an air heater disposed in the intake duct.

18. The apparatus of claim 17, wherein the air heater includes one of an electrically heated wire and a ceramic coated electrically heated wire.

19. The apparatus of claim 8, further comprising a fan disposed in the exhaust duct.

20. An air inlet of a clothes drying apparatus which uses a rotating drum, comprising:
an air receiving portion in communication with an ambient and which receives air to be delivered into the rotating drum; and
an air delivering portion having a convex wall extending into the rotating drum and having a plurality of through holes extending through the convex wall,
wherein air received by the receiving portion is radially delivered to the drum through the plurality of through holes.

21. A method of drying clothes in a clothes drying apparatus using a drum, comprising:
rotating the drum;
heating air;
delivering the heated air to the drum; and
radially supplying the heated air into the drum via an air inlet having a convex wall extending into the rotating drum and having a plurality of through holes extending radially through the convex wall and through which the hot air enters the drum.
